(19) United States
(12) Patent Application Publication
(10) Pub. No.: US 2012/0202504 A1
(43) Pub. Date: Aug. 9, 2012

(54) Method for Load Balancing in a Radio Communications System and Apparatus Thereof

(76) Inventors: Bernhard Wegmann, Holzkirchen (DE); Viering Ingo, Munich (DE)

(21) Appl. No.: 13/501,772

(22) PCT Filed: Oct. 16, 2009
(86) PCT No.: PCT/EP2009/063553

§ 371 Date: Apr. 13, 2012

(51) Int. Cl. H04W 36/22; H04W 28/08

(52) U.S. Cl. 455/438

(57) ABSTRACT

Method and apparatus thereof for load balancing in a radio communications system having a plurality of access nodes, including the steps of: two access nodes of said plurality exchange cell load information; a first access node having spare capacity and accepting load balancing requests from said second access node modifies a transmit power ratio between a data channel and a control channel such that load balancing is accomplished by handing over at least one user terminal or UE to the access node or cell re-selection of at least one user terminal or UE to the access node.

### FIELD OF THE INVENTION

The invention is used in a radio communications system to control a power increase in a radio communications system in order to ensure that load balancing is applied throughout such radio communications system and thus providing for an overall efficient traffic management.

### SUMMARY OF THE INVENTION

In radio communications systems, traffic between UEs (User Equipments) or user terminals and ANs (Access Nodes) is neither homogenously distributed over the service area covered nor is it temporarily constant, i.e. traffic hot spots will emerge for certain time frames somewhere and will vanish after some time while somewhere else another hot spot will emerge (time frames t₁, t₂) in FIG. 1. For a certain time frame some cells and their corresponding ANs are heavily loaded while the adjacent cells and their corresponding ANs have only a low traffic load. Dimensioning radio communications systems according to these instantaneous traffic peaks is inefficient, FIG. 2.

Load balancing (LB) is one way in which to improve the overall performance of radio communications systems for such in-homogeneous traffic situations. One way to execute load balancing would be to change handover (HO) threshold parameters between two neighbouring cells which show a huge traffic imbalance. The shift of HO thresholds results in handover of UEs located in or near the border of a congested cell to other neighbouring cells that have a lighter traffic load and are less congested.

With load balancing, the cells having a low traffic load become virtually larger and absorb some of the UEs from the overloaded neighbouring cell. Although these UEs are relative far from the new access node (AN), due to shifted HO threshold parameters, those UEs are forced to handover from an overloaded cell to a less loaded, but the larger distance of these UEs to the new AN causes that the new radio links will obviously suffer both from low signal strength and bad SINR (Signal to Interference plus Noise Ratio). For a data channel (also known as a shared channel in LTE (Long Term Evolution) radio communications systems) these drawbacks can be compensated by retransmissions and/or appropriate scheduling/radio resource allocation means, i.e. the low SINR UEs can simply be assigned more resources (also known as physical resource blocks (PRBs) in LTE).

However, those options are quite limited for control channels. More specifically, amongst the different control channels used for transmitting information between a UE and an AN, the Physical downlink control channel (PDCCH) contains the scheduling information for uplink and downlink. The Physical Broadcast channel contains part of the system information which is needed to inform the UE about modified configurations. The Physical Uplink Control Channel (PUCCH) contains measurement reports, other feedback information as well as HARQ information.

If these channels cannot be detected by the UE due to bad radio conditions, the data channel will be lost. This loss might cause an increase in signalling requesting retransmissions or even the loss of the connection. It is evident that the quality of the control channel will limit the potential of load balancing. It may occur that the low-loaded cell still has significant spare capacity (in terms of PRBs), such that it would be able to accommodate UEs from the overloaded neighbour. However, control channels may not allow since the UE cannot be reached with the important control information. This will reduce the efficiency of the radio communications system.

A need therefore exists for a technique that can provide support for UEs and ensure that the above issues are resolved and that UEs does not loose their connection or data and additionally increase the efficiency of the radio communications system.

With the present invention, the above mentioned issues are resolved. UEs located in or near the border of a congested cell can be handed over to neighbouring cells having less congestion, thus reducing the number of UEs present and allowing an efficient load balancing to be implemented within the radio communications system.

The technique is achieved by the teachings contained in the independent claims.

According to the independent method claim, a method is provided for load balancing in a radio communications system having a plurality of access nodes, comprising the steps of: two access nodes of said plurality exchange cell load information, the exchange being part of a load balancing procedure and a first access node having spare capacity and accepting load balancing requests from said second access node modifies a transmit power ratio between a data channel and a control channel such that load balancing is accomplished by handing over at least one user terminal or UE to the access node or cell re-selection of at least one user terminal or UE to the access node.

According to the independent apparatus claim, an access node comprising means adapted for load balancing in a radio communications system having a plurality of access nodes, comprises of control means arranged to bi-directionally exchange cell load information, the exchange being part of a load balancing procedure, the control means further arranged to determine whether to accommodate at least one user terminal from a second access node, and power modifying means arranged to modify a transmit power ratio between a data channel and a control channel.

Advantageous embodiments of the present invention are described by the dependent claims, wherein:

The received load balancing requests in combination with access node status information result in a modification of at least one handover threshold parameter, the modification effected upon a condition being present in the exchanged cell load information

The cell load information is exchanged on a peer-to-peer level between the first and the second access nodes.

The transmit power ratio is dynamically modified by simultaneously increasing the transmit power on the control channel and decreasing the transmit power on the data channel.

The modification of the transmit power ratio is done in a situation where the said access node has unused radio resources (PRB) and/or where the said access node detects an overloaded neighbouring access node.

The modification of the transmit power ratio is done in a situation where the said access node is overloaded and/or has already offloaded traffic to a neighbouring access node.

The transmit power ratio is modified upon receiving a handover message.

It is further pointed out that the invention may be realized by means of a computer program respectively software. According to a further refinement of the invention there is provided a computer-readable medium on which there is stored a computer program element for executing the steps of the method claim 1.

The program may be implemented as a computer readable instruction code in any suitable programming language, such as, for example, JAVA, C++, and may be stored on a computer-readable medium (removable disk, volatile or non-volatile memory, embedded memory/processor, control processor etc.). The instruction code is operable to program a computer or any other programmable device to carry out the intended functions. The program element may be available from a network, such as the World Wide Web, from which it may be downloaded.

However, the invention may also be realized by means of one or more specific electronic circuits respectively hardware. Furthermore, the invention may also be realized in a hybrid form, i.e. in a combination of software modules and hardware modules.

The computer-readable medium may be readable by a computer or a processor. The computer-readable medium may be, for example but not limited to, an electric, magnetic, optical, infrared or semiconductor system, device or transmission medium. The computer-readable medium may include at least one of the following media: a computer-distributable medium, a program storage medium, a record medium, a computer-readable memory, a random access memory, an erasable programmable read-only memory, a computer-readable software distribution package, a computer-readable signal, a computer-readable telecommunications signal, computer-readable printed matter, and a computer-readable compressed software package.

### SHORT DESCRIPTION OF THE DRAWINGS

The present invention will become more apparent from the description given herein below by way of illustration only, and thus are not limitative of the present invention and wherein:

FIG. 1 depicts a radio communications system wherein at two different points in time or time frames (t₁, t₂) different hot spots are present.

FIG. 2 depicts a radio communications system illustrating the resulting increase in hot spots when dimensioning the radio communications systems according to instantaneous traffic peaks.

FIG. 3 depicts a radio communications system wherein the invention can be implemented.

FIG. 4 depicts the steps performed by the inventive method.

FIG. 5 depicts in block diagram form an access node according to the invention.

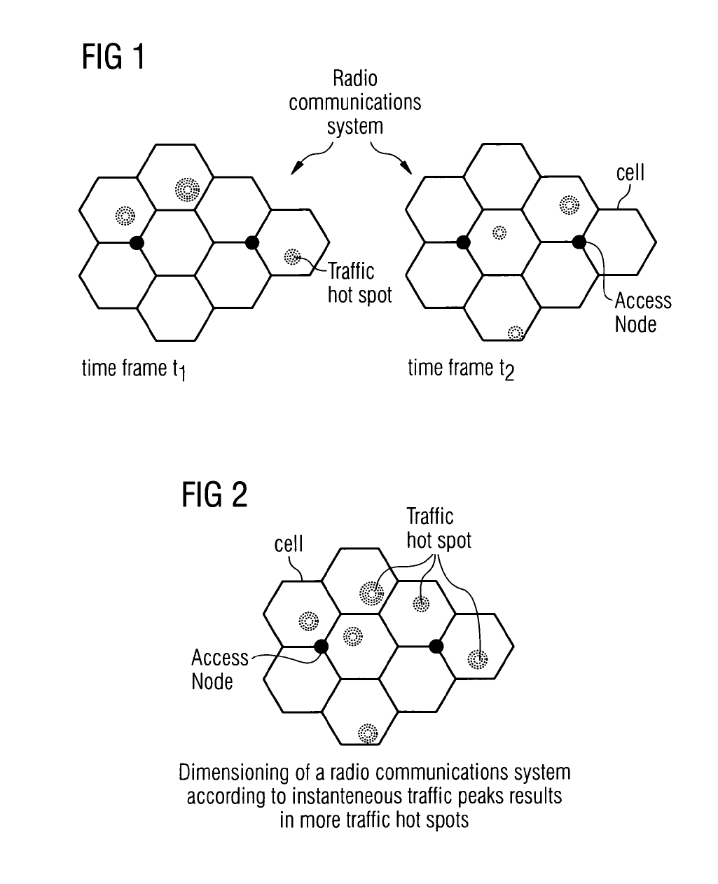

### DETAILED DESCRIPTION OF THE INVENTION

FIG. 3 depicts a radio communications system 1000 wherein the invention can be implemented. Such a radio communications system 1000 can use various types of radio technologies known within the 3^{rd} and 4^{th} generation (3G, 4G) groups of radio technologies such as, for example, UMTS (Universal Mobile Telecommunications System), LTE (Long Term Evolution), or LTE-A (Long Term Evolution-Advanced).

Radio communications system 1000 comprises of a plurality of access nodes 100 which are connected either individually or in groups to network controlling devices 200 which allow connection to a PSTN/ISDN (Public Switched Telephone Network/Integrated Services Digital Network) system 500. These network controlling devices 200 can be at least one of the following: a RNC (Radio Network Controller), BSC (Base Station Controller) or any other network device used for controlling access nodes. The access nodes (ANs) 100 can be one of the following: a BS (base station), an eNB (eNodeB). In 4G systems such as LTE and LTE-A, the network controlling device 200 is replaced by a gateway device, as a gateway device is used to connect to the PSTN/ISDN instead of a network controlling device such as an RNC which is used in 3G systems.

Each access node 100 in the radio communications system 1000 provides radio resources over a specified area, known as a cell. These radio resources allow UEs 10 present in the radio communications system 1000 and located within a cell to use the available radio resources to set up connections to other UEs or to other available services provided by a network operator.

In such a radio communications system 1000, traffic between UEs and ANs is neither homogenously distributed over the service area covered by the system nor is it temporarily constant. This can result in an overload of the radio resources provided by an access node in a particular cell. For a certain time frame some cells and their corresponding ANs are heavily loaded while the adjacent cells and their corresponding ANs have only a low traffic load.

In such a situation, in order to maintain the connection and ensure that the quality of service provided does not degrade further and also reduce the load on the available radio resources within the overloaded cell, a load balancing procedure is applied resulting in a handover or cell re-selection of a UE or a number of UEs to a neighbouring cell that has a low traffic load and thus more available radio resources. Such a procedure is also known as a forced handover.

The shift of handover threshold parameters as a result of the exchange of load information by the load balancing procedure triggers the modification of the access node internal transmit (Tx) power ratio. Load balancing provides this shift in handover threshold parameters in a way that the cells having a low traffic load become larger so that some of the UEs of the overloaded neighbouring cell are in a range where handover or cell re-selection can be initiated. The large distance causes that the radio connection between a user terminal or UE 10 and the new access node 100 will suffer both from low signal strength and bad SINR and can lead to loss of the connection and thus loss of data.

In order now to ensure that the connection is maintained the method provides for way for the access node 100 to adapt its power allocation.

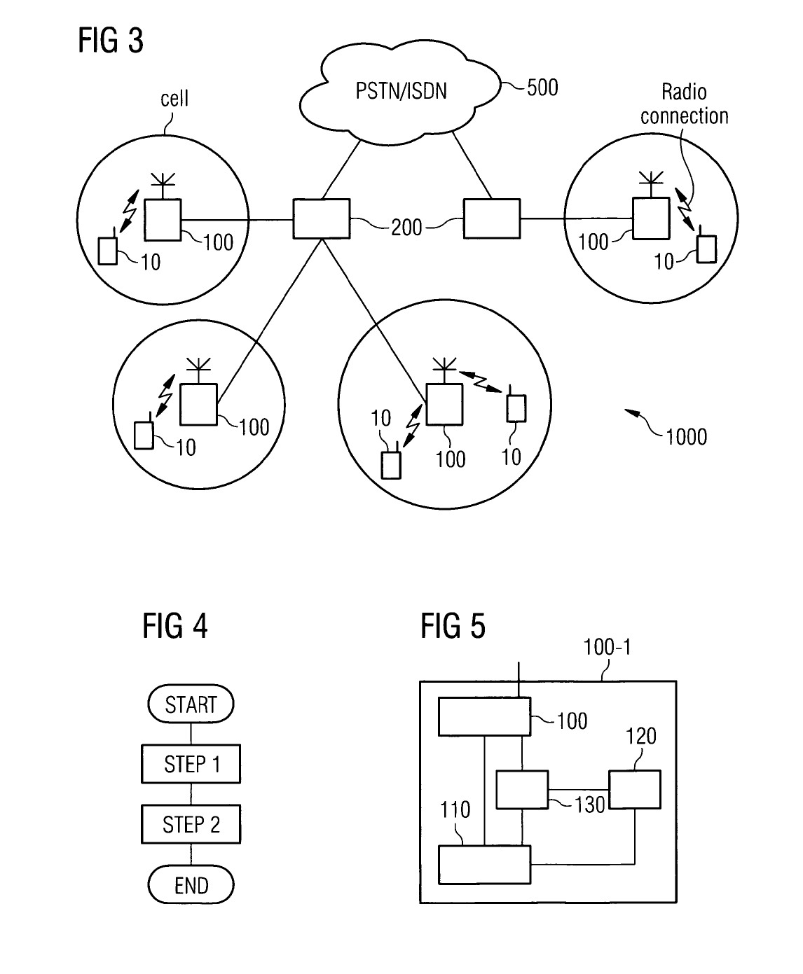

In order to render the invention more understandable in the following examples, access nodes 100 are further differentiated with reference signs 100-1, 100-2. The steps executed by the invention are shown in FIG. 4.

Two neighbouring access nodes 100-1, 100-2 exchange cell load information (step 1) as part of a load balancing procedure within the system 1000. A first access node (100-1) that has spare capacity and accepts load balancing requests from the second access node 100-2 modifies a transmit power ratio between a data channel and a control channel (step 2) such that load balancing is accomplished by handing over at least one user terminal or UE 10 to the access node 100-1 or cell reselection of at least one user terminal or UE 10 to the access node 100-1.

The handover is initiated upon a modification or shifting of at least one handover threshold parameter as a result of a condition being present in the exchanged cell load information. Neighbouring access nodes 100-1 and 100-2 exchange cell load information between them on a peer-to-peer level. This exchange of cell load information between the neighbouring access nodes 100-1, 100-2 forms part of a load balancing procedure executed within the system 1000. In the event that such a condition is present in the cell load information, the access node receiving the load balancing requests in combination with access node status information will modify at least one handover threshold parameter, the modification effected upon the condition being present in the exchanged cell load information. The condition can be a load imbalance condition and can be caused, for example, by a large number of user terminals 10 being present in the cell of access node 100-2 or by a large amount of traffic volume being present.

The transmit power ratio that access node 100-1 will modify is the ratio between a data channel and a control channel. The data channel carries data information between a UE 10 and an access node 100-1 or 100-2, while the control channel carries control information between a UE 10 and an access node 100-1 or 100-2. For instance, the control channel may be a dedicated control channel (CCH) such as the PDCCH, the PUCCH or the common CCH such as the PBC.

In a further refinement, the modified transmit power ratio is dynamically modified by simultaneously increasing the transmit power on the control channel and decreasing the transmit power on the data channel.

By increasing the transmit power on the control channel, AN 100-1 increases the range over which a control signal can be transmitted, thus increasing the size of its corresponding cell coverage. Through the increase of the cell coverage via the increase in the transmit power of the control channel, it is possible for UEs 10 that have been handed over to be able to receive messages over the control channels independently on whether the radio conditions within the cell are worse than in their previous cell. In this way, as the control channels are stronger in strength they can be received by the UEs 10 thus ensuring that the radio connection is not lost and consequently that it is not required for radio resources to be re-assigned after a connection is lost in order to start the procedure for re-establishing the connection. Additionally, as the cell coverage of the low loaded cell increases due to the shift of the handover threshold parameters, it will cover more area and thus overlap with the cell area of the overloaded cell, which in turn will be simultaneously reduced in area, thus enabling additional UEs 10 located within the overloaded cell to be handed over. In this way the overloaded cell can reduce its traffic load, thus permitting load balancing to be effected within the cell as well as increasing the overall efficiency of the system 1000.

By dynamically modifying the transmit power ratio through a simultaneous increase of the transmit power on the control channel and decrease of the transmit power on the data channel a balanced power budget can be maintained and ensuring that the available power at access node 100-1 is efficiently used. The modification of the transmit power ratio is done in a situation where the said first access node 100-1 has unused radio resources (called Physical Resource Block (PRB) in LTE) and/or where the said first access node 100-1 detects an overloaded neighbouring access node. Furthermore, the modification of the transmit power ratio is done in a situation where access node 100-2 is overloaded and/or has already off-loaded traffic to a neighbouring access node and also upon receiving a handover message. Furthermore, the load balancing procedure is accomplished with at least one of the following: a handover parameter, a cell reselection parameter.

FIG. 5 depicts in block form an access node 100-1 according to the invention. Access node 100-1 comprises of transceiver means 100 arranged to transmit and receive data, information or messages from user terminals 10 and other access nodes on both data and control channels. The node also comprises control means 110 that are arranged to bi-directionally exchange cell load information via the transceiver means 100, the exchange being part of a load balancing procedure. The control means 110 are further arranged to determine whether to accommodate at least one user terminal 10 from a second access node 100-2. This determination can be made by verifying whether the access node 100-1 has unused radio resources available which it can allocate to a user terminal 10 originating in the cell controlled by access node 100-2. It also comprises power modifying means 120 arranged to modify a transmit power ratio between a data channel and a control channel. The control means 110 are further arranged to modify at least one handover threshold parameter upon a condition being present in the exchanged cell load information. Additionally, control means 110 are further arranged to exchange cell load information with the second 100-2 access node and the means 110 are further arranged to the cell load information on a peer-to-peer level with the second 100-2 access node. The control means 110 are further arranged to modify at least one of the following: a handover parameter, a cell re-selection parameter, as part of the load balancing procedure. In addition as part of the load balancing procedure, control means 110 are further arranged to initiate at least one of the following: a handover, a cell reselection.

The power modifying means 120 are further arranged to dynamically modify the transmit power ratio by simultaneously increasing the transmit power on the control channel and decreasing the transmit power on the data channel.

Access node 100-1 also has power means 130 that provide power resources for the functioning of the access node. The modification of the transmit power ratio by the power modifying means 120 will cause the power means 130 to modify the power used for transmission via the transceiver means 100 on the control channel and data channel.

In the event that the cell load information message indicates a huge load imbalance of the corresponding cells to a commonly agreed configuration parameter, control means 110 modify the HO threshold parameters. Once the modification is effected, power modifying means 120 are arranged to modify a transmit power ratio of access node 100-1. This modification results in a handover of at least one user terminal or UE 10 to the access node 100-1 or cell re-selection of at least one user terminal or UE 10 to the access node 100-1. The different means can be realized by means of one or more specific electronic circuits or processors.

In addition, the invention can also be implemented as a computer program element for executing the steps of the invention. The program may be implemented as a computer readable instruction code in any suitable programming language, such as, for example, JAVA, C++, and may be stored on a computer-readable medium (removable disk, volatile or non-volatile memory, embedded memory/processor, control processor etc.). The instruction code is operable to program a computer or any other programmable device to carry out the intended functions. The program element may be available from a network, such as the World Wide Web, from which it may be downloaded.

Although the invention has been described in terms of preferred embodiments and refinements described herein, those skilled in the art will appreciate other embodiments and modifications which can be made without departing from the scope of the teachings of the invention. All such modifications are intended to be included within the scope of the claims appended hereto.

1. A Method for load balancing in a radio communications system having a plurality of access nodes, comprising the steps of:
two access nodes of said plurality exchange cell load information, said exchange being part of a load balancing procedure;
a first access node having spare capacity and accepting load balancing requests from said second access node modifies a transmit power ratio between a data channel and a control channel such that load balancing is accomplished by handing over at least one user terminal or UE to the access node or cell re-selection of at least one user terminal or UE to the access node.

2. The method according to claim 1, wherein said received load balancing requests in combination with access node status in-formation result in a modification of at least one handover threshold parameter, said modification effected upon a condition being present in the exchanged cell load information

3. The method according to claim 2, wherein said cell load information is exchanged on a peer-to-peer level between said first and said second access nodes.

4. The method according to claim 1, wherein said transmit power ratio is dynamically modified by simultaneously increasing the transmit power on said control channel and decreasing the transmit power on said data channel.

5. The method according to claim 1, wherein the modification of the transmit power ratio is done in a situation where the said first access node (100-1) has unused radio resources (PRB) and/or where the said first access node (100-1) detects an overloaded neighbouring access node.

6. The method according to claim 1, wherein the modification of the transmit power ratio is done in a situation where the said access node is overloaded and/or has already offloaded traffic to a neighbouring access node.

7. The method according to claim 1, wherein transmit power ratio is modified upon receiving a handover message.

8. The method according to claim 1, wherein the load balancing procedure is accomplished with at least one of the following:
a handover parameter, a cell reselection parameter.

9. An access node comprising means adapted for load balancing in a radio communications system having a plurality of access nodes, comprising:
control means arranged to bi-directionally exchange cell load information, said exchange being part of a load balancing procedure;
control means further arranged to determine whether to accommodate at least one user terminal from a second access node, and
power modifying means arranged to modify a transmit power ratio between a data channel and a control channel.

10. The access node according to claim 9, wherein said control means are further arranged to modify at least one handover threshold parameter upon a condition being present in the exchanged cell load information.

11. The access node according to claim 9, wherein said control means are further arranged to exchange cell load information with said second access node.

12. The access node according to claim 9, wherein said control means are further arranged to exchange said cell load information on a peer-to-peer level with said second access node.

13. The access node according to claim 9, wherein said power modifying means are further arranged to dynamically modify said transmit power ratio by simultaneously in-creasing the transmit power on said control channel and decreasing the transmit power on said data channel.

14. The access node according to claim 9, wherein said control means of the load balancing procedure are further arranged to modify at least one of the following: a handover parameter, a cell reselection parameter.

15. The access nodes according to claim 9, wherein said control means of the load balancing procedure are further arranged to initiate at least one of the following: a handover, a cell reselection.
